(19) United States
(12) Patent Application Publication
(10) Pub. No.: US 2008/0120244 A1
(43) Pub. Date: May 22, 2008

(54) AUTOMATED NEGOTIATION SYSTEM AND METHOD

(76) Inventor: David M. Mello, Concord, MA (US)

Correspondence Address: David M. Mello, 41 Old Bridge Road, Concord, MA, 01742, US

(21) Appl. No.: 11/943,685

(22) Filed: Nov. 21, 2007

Related U.S. Application Data
(60) Provisional application No. 60/866,795, filed on Nov. 21, 2006.

(51) Int. Cl. G06Q 30/00

(52) U.S. Cl. 705/80; 705/37

(57) ABSTRACT

A negotiation system can include at least one negotiation database configured to store a set of seller information comprising a subject matter identification and a set of seller price information including a list price and a lowest price, the subject matter identification identifying a subject matter of a negotiation, a set of buyer information comprising a set of buyer price information including an offer price and a maximum price for the subject matter, and a negotiation module configured to determine a negotiated price from the seller price information and the buyer price information. An automated negotiation method comprises steps to perform the foregoing.

### CROSS REFERENCES TO RELATED APPLICATIONS

This application claims the benefit of priority under 35 U.S.C. §119(e) from co-pending, commonly owned U.S. provisional patent application Ser. No. 60/866,795, entitled AUTOMATED NEGOTIATION SYSTEM AND METHOD, filed Nov. 21, 2006, the disclosure of which is incorporated herein in its entirety by reference.

### FIELD OF INTEREST

The present inventive concepts relate to the field of electronic commerce. More particularly, the concepts related to systems and methods in contexts where negotiations are involved.

### BACKGROUND

In many situations potential buyers reluctantly begin the process of negotiating for a desired good or service, as examples, because the negotiation process can be time consuming, frustrating and stressful. The fact is, many people do not like to negotiate.

For example, a car buying situation is one that for many is unpleasant, merely for the fact that negotiation with a sales person, or team of sales people, will be required. These sales people are often trained and experienced negotiators, working in a team, in an environment that is comfortable to them, and not to the buyer. It is understandable that a buyer might feel at a disadvantage in that process.

A home purchase situation is another in which buyers often find the negotiation process to be time consuming, stressful and unpleasant. In this situation, while the seller might not have more experience than the buyer, the seller's agent often will. Having such an expensive and important asset at stake makes the process stressful for most. The negotiation process compounds the stress for many.

Negotiations can be time consuming, as buyers and sellers go back and forth with offers and counter offers. As a result, during the negotiation process other potential opportunities are lost for both the buyer and the seller. That is, other potential buyers continue looking at other properties, while the seller is tied up in a negotiation that could ultimately be unsuccessful. And the buyer is tied up while other desirable properties go off the market. Thus, both parties bare some risk in entering a negotiation.

### SUMMARY OF INVENTION

In accordance with another aspect of the present invention, provided is a method of automated negotiation, implemented using one or more computers, the method comprising: storing in at least one negotiation database a set of seller information comprising a subject matter identification and a set of seller price information including an asking price and a lowest price, the subject matter identification identifying a subject matter of a negotiation, and a set of buyer information comprising a set of buyer price information including an offer price and a maximum price for the subject matter. The method further includes determining a negotiated price from the seller price information and the buyer price information.

The method can further comprise determining a seller price range defined by the asking price and the lowest price, and determining a buyer price range defined by the offer price and the maximum price.

The method can further comprise determining an overlap of the seller price range and the buyer price range and determining the negotiation price to be within the overlap.

The method can further comprise determining the overlap as a range having one end point at the higher of the lowest price and offer price and another end point at the lower of the asking price and maximum price.

The method can further comprise determining the negotiated price as a midpoint of the overlap.

The method can further comprise determining the negotiated price by weighting at least one of the seller price information and buyer price information.

The method can further comprise refusing to determine the negotiated price if the seller lowest price is greater than the buyer maximum price.

The method can further comprise determining the negotiate price as a proposed negotiated price if the seller lowest price is greater than the buyer maximum price.

The method can further comprise determining the proposed negotiated price as being between the seller lowest price and the buyer maximum price.

The method can further comprise determining a market value of the subject matter and determining the negotiated price as a further function of the market value.

The method can further comprise determining the negotiated price as being within a predetermined percentage of the market value.

The method can further comprise determining at least one market value of the subject matter in response to a user action.

The method can further comprise querying one or more external systems configured to provide market values for determining the at least one market value.

The method can further comprise determining the negotiated price only if the set of seller information includes information indicating a commitment to sell the subject matter at the negotiated price, prior to determination of the negotiated price.

The method can further comprise determining the negotiated price only if the set of buyer information includes information indicating a commitment to buy the subject matter at the negotiated price, prior to determination of the negotiated price.

The method can further comprise providing a user interface for enabling the input of at least one of the seller information and buyer information to the at least one negotiation database.

The method can further comprise providing a user interface for generating an output configured for presentation on a user device, the output including the negotiated price.

The method can further comprise generating a contract for the purchase of the subject matter by the buyer and from the seller for the negotiated price.

The subject matter can be real estate.

The subject matter can be at least one vehicle.

The subject matter can be goods and/or services.

In accordance with another aspect of the present invention provided is a method of automated negotiation, implemented using one or more computers, the method comprising: storing in at least one negotiation database a set of seller information comprising a subject matter identification and a set of seller price information including an asking price and a lowest price, the subject matter identification identifying a subject matter of a negotiation, and a set of buyer information comprising a set of buyer price information including an offer price and a maximum price for the subject matter. The method further comprises determining a negotiated price from the seller price information and the buyer price information and generating a user interface for presentation on a user device, the user interface configured for input and output of one or more of the buyer information, seller information and the negotiated price.

The method can further comprise determining a price range overlap as a range having one end point at the higher of the lowest price and offer price and another end point at the lower of the asking price and maximum price, and determining the negotiated price to be within the overlap.

The subject matter can be real estate.

The subject matter can be at least one vehicle.

The subject matter can be good and/or services.

In accordance with one aspect of the present invention, provided is a negotiation system comprising at least one negotiation database configured to store: a set of seller information comprising a subject matter identification and a set of seller price information including an asking price and a lowest price, the subject matter identification identifying a subject matter of a negotiation; and a set of buyer information comprising a set of buyer price information including an offer price and a maximum price for the subject matter. The system further comprises a negotiation module configured to determine a negotiated price from the seller price information and the buyer price information.

The negotiation module can be further configured to determine a seller price range defined by the asking price and the lowest price, and a buyer price range defined by the offer price and the maximum price.

The negotiation module can be further configured to determine an overlap of the seller price range and the buyer price range and to determine the negotiation price to be within the overlap.

The negotiation module can be further configured to determine the overlap as a range having one end point at the higher of the lowest price and offer price and another end point at the lower of the asking price and maximum price.

The negotiation module can be further configured to determine the negotiated price as a midpoint of the overlap.

The negotiation module can be further configured to weight at least one of the seller price information and the buyer price information and to determine the negotiated price using the weighted information.

The negotiation module can be further configured to refuse determination of the negotiated price if the seller lowest price is greater than the buyer maximum price.

The negotiation module can be further configured to determine the negotiate price as a proposed negotiated price if the seller lowest price is greater than the buyer maximum price.

The negotiation module can be configured to determine the proposed negotiated price as being between the seller lowest price and the buyer maximum price.

The negotiation module can be further configured to determine a market value of the subject matter and to determine the negotiated price as a further function of the market value.

The negotiation module can be further configured to determine the negotiated price as being within a predetermined percentage of the market price.

The negotiation module can be further configured to determine at least one market value of the subject property in response to a user action.

The negotiation module can be further configured to query one or more external systems configured to provide market values to determine the at least one market value.

The negotiation module can be configured to determine the negotiated price only if the set of seller information includes information indicating a commitment to sell the subject matter at the negotiated price, prior to determination of the negotiated price.

The negotiation module can be configured to determine the negotiated price only if the set of buyer information includes information indicating a commitment to buy the subject matter at the negotiated price, prior to determination of the negotiated price.

The system can further comprise a user interface module configured to enable the input of at least one of the seller information and buyer information to the at least one negotiation database.

The system can further comprise a user interface module further configured to generate an output configured for presentation on a user device, the output including the negotiated price.

The system can further comprise a contract module configured to generate a contract for the purchase of the subject matter by the buyer and from the seller for the negotiated price.

The subject matter can be real estate.

The subject matter can be at least one vehicle.

The subject matter can be goods and/or services.

In accordance with another aspect of the invention, provided is a negotiation system comprising: a negotiation database, a negotiation module and a user interface module. The negotiation database is at least one negotiation database configured to store a set of seller information comprising a subject matter identification and a set of seller price information including an asking price and a lowest price, the subject matter identification identifying a subject matter of a negotiation, and a set of buyer information comprising a set of buyer price information including an offer price and a maximum price for the subject matter. The negotiation module is configured to determine a negotiated price from the seller price information and the buyer price information. And the user interface module is configured to generate a user interface for presentation on a user device, the user interface is configured for input and output of one or more of the buyer information, seller information and the negotiated price.

The negotiation module can be further configured to determine a price range overlap as a range having one end point at the higher of the lowest price and offer price and another end point at the lower of the asking price and maximum price, and is further configured to determine the negotiated price to be within the overlap.

The subject matter can be real estate.

The subject matter can be is at least one vehicle.

The subject matter can be goods and/or services.

In any of the foregoing, the subject matter can be anything for which a negotiation is conducted. Real estate, vehicles and goods and/or services are merely examples. Other examples could include art or other collectibles, stocks, bonds, financial instruments, commodities, and so on.

In accordance with another aspect of the invention, the seller price range can be determined based on an input seller asking price and a percentage that establishes the seller lowest price.

In accordance with another aspect of the invention, the seller price range can be determined based on an input seller lowest price and a percentage that establishes the seller offer price.

In accordance with another aspect of the invention, the buyer price range can be determined based on an input buyer offer price and a percentage that establishes the buyer maximum price.

In accordance with another aspect of the invention, the buyer price range can be determined based on an input buyer maximum price and a percentage that establishes the buyer offer price.

In accordance with another aspect of the invention, provided is a negotiation system comprising at least one negotiation database configured to store: a set of seller information comprising a subject matter identification and a set of seller price information including an asking price and a lowest price, the subject matter identification identifying a subject matter of a negotiation; and, for each of a plurality of buyers, a set of buyer information comprising a set of buyer price information including an offer price and a maximum price for the subject matter. The system further comprises a negotiation module configured to determine a negotiated price associated with each buyer from the seller price information and the respective buyer price information.

The negotiation module can further be configured to determine a winning bid as a function of the negotiated prices.

The negotiation module can further be configured to determine the winning bids as a further function of a set of related transaction requirements.

In accordance with another aspect of the present invention, provided is a method of automated negotiation, implemented using one or more computers, the method comprising: storing in at least one negotiation database a set of seller information comprising a subject matter identification and a set of seller price information including an asking price and a lowest price, the subject matter identification identifying a subject matter of a negotiation, and, for each of a plurality of buyers, a set of buyer information comprising a set of buyer price information including an offer price and a maximum price for the subject matter. The method further includes determining a negotiated price associated with each buyer from the seller price information and the respective buyer price information.

The method can further comprise determining a winning bid as a function of the negotiated prices.

The method can further comprise determining the winning bids as a further function of a set of related transaction requirements.

### BRIEF DESCRIPTION OF THE DRAWINGS

The drawing figures depict preferred embodiments of aspects of the present invention by way of example, not by way of limitation. In the figures, like reference numerals refer to the same or similar elements.

FIG. 1 is a flowchart depicting an embodiment of a method of automated negotiation in accordance with aspects of the present invention.

FIG. 2 is a block diagram of a system that can be used to implement an automated negotiation method, such as that of FIG. 1.

FIG. 3 is a block diagram depicting an automated negotiation system implemented in a bidding context.

FIGS. 4A-C are embodiments of seller screens via which the seller can input property and price information.

FIG. 5 is an embodiment of a listing screen that can be presented to a potential buyer.

FIG. 6A is an embodiment of a buyer offer input screen and FIG. 6B is an embodiment of a successful buyer notification screen.

FIG. 7A is an embodiment of an auction buyer input screen and FIG. 7B is an embodiment of a successful bidder notification screen.

### DETAILED DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or directly connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In accordance with the disclosure, and the illustrative embodiments herein, provided is a system and method for automated negotiation between at least two parties. The negotiation, in the preferred forms, requires limited or no direct contact or “back-and-forth” between the parties, e.g., a buyer and a seller.

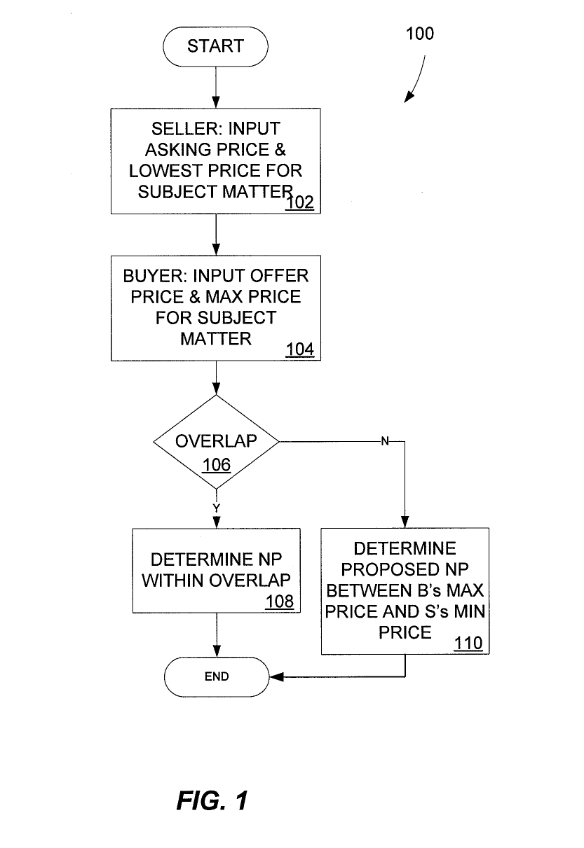

FIG. 1 is a flowchart 100 depicting an embodiment of an automated negotiation transaction method, in this case a sale between one buyer and one seller for a subject matter (e.g., real estate, vehicles, goods, or services), in accordance with the present disclosure. One or more of the steps of the flowchart are carried by at least one computer, which generates and provides an automated negotiation price, without haggling by the parties. As a starting point, presume that the subject matter (e.g., an item) has been identified and the buyer wants to buy it and the seller wants to sell it.

In step 102 the seller enters an asking (or list) price (AP) and a minimum or lowest price (LP) for the subject matter (e.g., a good, such as a car or house). This may be done, for example, at a time of placing an ad for the item or it may be done in response to a prompt from the buyer indicating an interest in negotiating for or buying the subject matter. As will be discussed in greater detail below, AP and LP can define a seller's price range (or seller range). Presumably, the seller's AP and LP reflect the negotiability of the seller.

In some embodiments, the seller can enter only one of AP or LP and the other can be determined for the seller. For example, the seller could enter an LP of $300,000 for its house and AP could be calculated as a price 20% higher than LP, in this case AP=$360,000. Conversely, the seller could enter an AP of $360,000 and the system could determine an LP for which AP is 20% greater, here LP=$300,000.

In step 104 the buyer enters an offer price (OP) and a maximum price (MP) for the subject matter. Only AP is made available to the buyer prior to the buyer entering its OP and MP. As will be discussed in greater detail below, OP and MP can define a buyer's price range (or buyer range). Similar to the seller, the buyer's OP and MP presumably reflect the negotiability of the buyer.

The seller's LP is not made available to the buyer. Optionally, OP can be made available to the seller, but preferably MP is not disclosed to the seller. Thus, in this illustrative embodiment, neither the seller's nor the buyer's negotiation position has been compromised by disclosure to the other of the limits of their respective positions.

In some embodiments, a step for determining or obtaining an appraised or market value can be added, which could also be provided to the buyer and/or seller. This step could be provided as an option to the buyer and/or seller, i.e., to obtain an appraised or market value, and could require payment of a fee by the requesting buyer and/or seller. The appraised value could be used as a benchmark by the buyer for establishing OP and MP and by the seller for establishing AP and LP.

In some embodiments, the buyer can enter only one of OP or MP and the other can be determined for the buyer. For example, the buyer could enter an OP of $300,000 for a house of interest and MP could be calculated as a price 20% higher than OP, in this case OP=$360,000. Conversely, the buyer could enter an MP of $360,000 and the system could determine an OP for which MP is 20% greater, here OP=$300,000.

In step 106, a determination is made of whether there is an overlap of a price range of the buyer and a price range of the seller. If there is, presumably an automated negotiated price can be determined that will be acceptable to the both parties.

The seller's range can be determined as the price range that has AP and LP as its endpoints. The buyer's range can be determined as the price range that has OP and MP as its endpoints. In this embodiment, if there is an overlap between the seller's range and the buyer's range then a negotiated price will result, as shown in step 108.

Optionally, a step 110 can be included where a proposed negotiated price is determined, i.e., where there is no overlap, so the answer in step 106 was “no.” In such a case the proposed negotiated price can be between the seller's LP and the buyer's MP.

Here is provided one possible illustrative example of the method of FIG. 1. Table 1 below provides the seller entered asking price AP and lowest price LP and the buyer entered offer price OP and maximum price MP. From this information a seller price range and a buyer price range can be determined, as is also reflected in Table 1.

TABLE 1

| Seller | Buyer |
|---|---|
| AP = $100K | OP = $80K |
| LP = $70K | MP = $100K |
| seller range $100K-$70K | buyer range $100K-$80K |
| Med_S = $85K | Med_B = $90K |

As is evident from Table 1, there is an overlap between the seller price range and the buyer price range. An automated negotiated price (NP) can be determined within this overlap. This can be done in one of few different ways.

In a first approach, a median or average price for the seller price range is determined and a median or average price for the buyer price range is determined. Med_S is the median point of the seller's range and Med_B is the median point of the buyer's range. For this example, Med_S and Med_B are shown in Table 1 above.

Given the values in Table 1, the automated negotiated price (NP) can be determined as the average of the medians, according to the following equation:

NP=(Med_S+Med_B)/2 (EQ. 1)

Using Equation (1) NP=$87.5K given the values of Table 1.

The approach yields a result that would satisfy the buyer and the seller, because the negotiated price falls within both the buyer's range and the seller's range. It is relatively easy to see how the hidden inputs of each user affect the ultimate negotiated price.

In a different approach, if the buyer's OP is within the seller's price range, then NP=OP. So using Table 1, the buyer's OP=$80K, which is within the seller's price range of $70K-$100K, thus NP=OP=$80K. While this approach yields a result that should be acceptable to buyer and seller, the seller does not get any benefit of a negotiation, since there is not any under this approach, and the determination of NP favors the buyer. Thus, a seller could tend to get less for its property.

In another approach, if the buyer's max price MP is not less than seller's lowest price LP, then NP=MP. So using Table 1, the buyer's MP=$100K, which is greater than seller's LP if $70K, thus NP=MP=$100K. While this approach yields a result that should be acceptable to buyer and seller, the buyer does not get any benefit of a negotiation, since there is not any under this approach, and the determination of NP favors the seller. Thus, a buyer could tend to pay more to buy the property.

In yet another approach, if Med_B is within the seller's price range, then NP=Med_B. So using Table 1, the buyer's Med_B=$90K, which is within the seller's price range of $70K-$100K, thus NP=Med_B=$90K. This approach also yields a result that should be acceptable to buyer and seller.

In yet another approach, if Med_S is within the buyer's price range than NP=Med_S. So using Table 1, the seller's Med_S=$85K, which is within the buyer's price range of $80K-$100K, thus NP=Med_S=$85K. This approach also yields a result that should be acceptable to buyer and seller.

In yet another approach the higher of the Med_S and Med_B is chosen to equal NP, assuming the higher of Med_S and Med_B is within the seller price range and the buyer price range.

In various approaches, if buyer's OP is higher than seller's AP, then NP=OP. That is, in such a case there would be no advantage for the seller by negotiating down from the buyer's offer price OP.

Table 2 below provides different data for another example. As shown in Table 2, there is no overlap between the seller price range and buyer price range, which was the case in the “no” situation for decision box 106 in FIG. 1.

TABLE 2

| Seller | Buyer |
|---|---|
| AP = $100K | OP = $80K |
| LP = $98K | MP = $90K |
| seller range $100K-$98K | buyer range $90K-$80K |
| Med_S = $99K | Med_B = $85K |

Using Equation (1), NP=(99K+85K)/2=$92K.

The NP of $92K does not fall within the price range of either the buyer or the seller. Therefore, one outcome could be that a negotiated price cannot be achieved and the process could be terminated. In a system that implements the method, the system could return a message to that effect, e.g., “A negotiated price could not be determined based on the input information.” Or the system could present some other indication of the inability to determine a negotiated price. The buyer, for example, could be prompted to enter new values, in some embodiments.

In some embodiments, when there is no overlap in the price ranges of the buyer and seller, a proposed negotiated price (PNP) could be generated and offered as a “Yes” or “No” option to the seller and/or buyer. As an example, the PNP could be determined as LP of the seller and the buyer could be given a “Yes” or “No” option to accept the PNP as the NP. Optionally, the seller could also be given a chance to accept the PNP as the NP.

Conversely, in another embodiment, the MP of the buyer could be determined as the PNP and the seller could be given a “Yes” or “No” option to accept that PNP as the NP. Optionally, the buyer could also be given a chance to accept the PNP as the NP.

In another example, the proposed negotiation price could be determined between the seller price range and the buyer price range, such as the $92K above. If both agree, the proposed negotiated price, PNP, becomes the NP.

For the data of Table 1, another option exists for determining NP in step 108 of FIG. 1 based on the overlap of the buyer's and seller's ranges. The overlap can be determined by taking the higher of LP and OP (as OLl) and the lower of AP and MP (as OLh). Thus, the price range overlap OL from the numbers above is a range from OLl-OLh, or $80K-$100K in this example. NP can be determined as the midpoint of that range, as follows in Equation (2):

NP=(OLl+OLh)/2 (EQ. 2)

Using this equation NP=$90K, which is different from the NP determined above using Equation (1) of $87.5K.

The combined range, determined here as the overlap of the seller's price range and the buyer's price range is $80K-$100K. In this embodiment, the negotiated price NP is determined as the midpoint of the overlap, here $90K. As a result, the negotiated price of $90K is within the acceptable range of both the buyer and the seller, so represents a price that should be acceptable to each. More specifically, NP falls between the seller's AP and the buyer's OP.

Equation (2) can also be used with the data of Table 2. LP is higher than OP, so OLl=LP=$98K. And MP is lower that AP, so OLh=MP=$90K. However, OLh<OLl, so a negotiated price that falls within both the buyer's range and the seller's range cannot be determined—because the buyer's and seller's price ranges do not overlap.

Depending on the embodiment, a proposed negotiated price (PNP), as in step 110 of FIG. 1, could be offered to the buyer and seller. Using the above information of OLh=$90K and OLl=$98K, PNP could be determined as some point there between. In this example, PNP could be chosen as the midpoint between $98K and $90K, i.e., PNP=$94K. If the buyer and seller assent to it, then the PNP becomes the NP.

Table 3 below provides a different set of possible data, where there is an overlap of the buyer's and seller's price ranges:

TABLE 3

| Seller | Buyer |
|---|---|
| AP = $100K | OP = $90K |
| LP = $90K | MP = $92K |
| seller range $90K-$100K | buyer range $90K-$92K |
| Med_S = $95K | Med_B = $91K |

Thus, the seller's price range is $100K-$90K, for a midpoint of $95K. The buyer's price range is $90K-$92K, for a midpoint of $91K. Using Equation (1):

NP=($95K+$91K)/2=$93K.

NP using Equation (1) falls outside of the buyer's price range—suggesting that a negotiated price is not possible.

However, using Equation (2) there is a different result. The overlap using the data of Table 3 is $90-$92K, i.e., OLl=$90K and OLh=$92K. Again, the overlap is determined by taking the higher of LP and OP (as OLl) and the lower of AP and MP (as OLh).

Using Equation (2):

NP=($90K+$92K)/2=$91K

Thus Equation (2) yields a resultant NP that is acceptable to both buyer and seller, since it falls within the price range of each.

In the preferred form, measures can be taken to ensure that buyers and sellers cannot “game” the system. In accordance with some embodiments, there is a certain amount of protection in such circumstances. In fact, the approaches above in Equation (1) and Equation (2) provide a certain level of protection.

For example, Table 4 provides and instance where a buyer tries to game the system with an unrealistically low offer price, OP.

TABLE 4

| Seller | Buyer |
|---|---|
| AP = $100K | OP = $0K |
| LP = $90K | MP = $92K |
| seller range $90K-$100K | buyer range $0K-$92K |
| Med_S = $95K | Med_B = $46K |

Here, the buyer may be presuming a pure “split the difference” approach will lead to the buyer getting an unreasonably low price. In fact, applying Equation (1) an acceptable NP could not be determined, because Med_S=$95K and Med_B=$45K. The resultant NP is $70K is below the seller's LP, so would be rejected. However, one of the above approaches could be used to determine a PNP.

In contrast, Equation (2) yields the same result as obtained with the data for Table 3, because OLl would be $90K and OLh=$92K. Thus, an overlap of $92K-$90K still results. NP would be determined as $91K, i.e., only $1,000 below the buyer's maximum price.

Closing the negotiation could be done in a variety of manners. In one embodiment, the seller and buyer agree beforehand to accept the negotiated price NP, e.g., a price that falls within their respective ranges. This is the most efficient automated negotiation because it is done completely by the negotiation system after the seller and buyer have provided their initial inputs, and yields an outcome that brings closure to the negotiation aspect of the transaction—so the transaction itself can proceed to closure. Using this approach, the negotiation can be completed nearly instantaneously—without days of haggling by the parties.

In another embodiment, the buyer and seller could each be given an opportunity to accept the negotiated price once determined. For example, the negotiation system outputs the negotiated price (NP), but either one or both of the buyer and seller have to assent to NP once it has been determined. In this embodiment, to keep the buyer or seller, or both, from iteratively trying to use the negotiation system to get an optimum NP, the system may prevent the buyer and seller from negotiating with the system for a period of time after each negotiation session or attempt. For example, the system could require that the buyer has to wait three days (or some other amount of time) to attempt a subsequent negotiation with the seller for the same subject matter (e.g., house or vehicle).

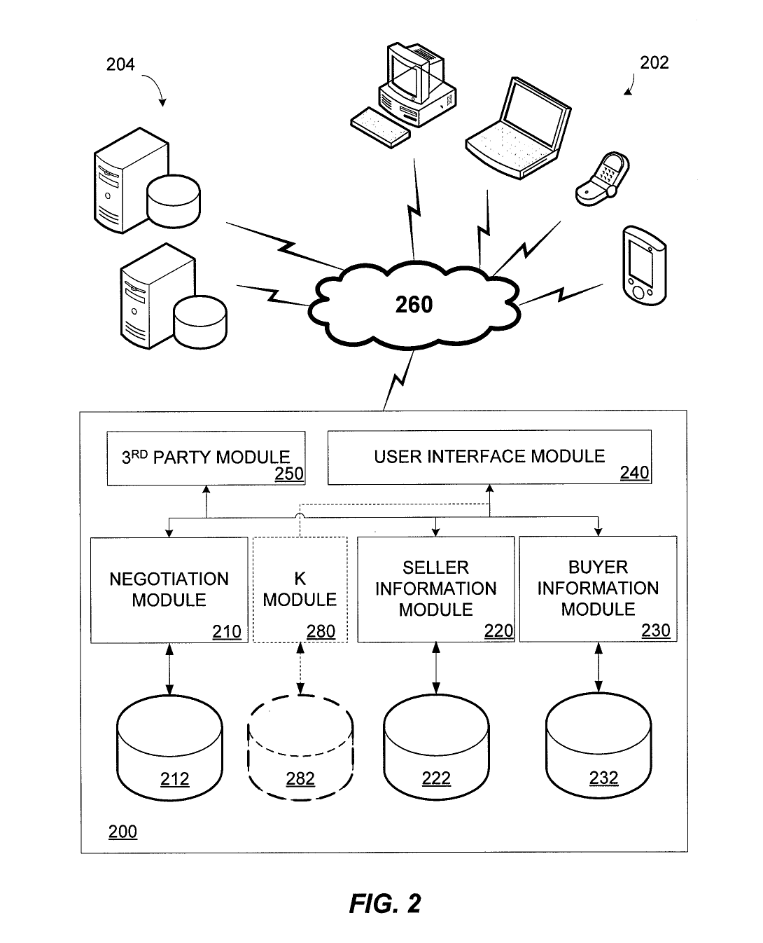

FIG. 2 is a block diagram of a system 200 that can be used to implement a method for conducting an automated negotiation, such as those described above, which may be referred to as an automated negotiation system. System 200 could be configured to communicate and exchange data with buyers and sellers via any known or hereinafter developed network enabled device 202, such as a personal computer, laptop computer, gaming system, cable television system, telephone system (including cell phone systems), personal digital assistance (PDA), or the like. System 200 could also be configured to communicate and exchange information with any of a variety of third party or support systems 204, such as appraisal, credit reporting, finance or lender, title verification or recordation, insurance, law enforcement, tariff, delivery, government, and administrative systems. In the above noted communications, the communication could take place over any type of known or later developed wired or wireless network, or combination thereof, such as the Internet, Worldwide Web, local area network, wide area network, virtual network, cable television network, phone network, or the like, or combination thereof, whether public or private. For simplicity, the foregoing networks are presented as network cloud 260 in FIG. 2.

In the embodiment of FIG. 2, the automated negotiation system 200 includes a set of functional modules that can be implemented as computer program code stored in one or more storage devices and executed by one or more processors, whether collocated or disparate. Otherwise, such functional modules can be implemented in hardware or firmware—or a combination of hardware, firmware, and/or software. The system also includes a set of databases, which could be merged into a single database system or distributed among several database systems.

Illustrative system 200 of FIG. 2 includes a negotiation module 210, a seller module 220, and a buyer module 230. In the illustrative embodiment of FIG. 2 general negotiation and management information is stored in a negotiation DB 212, seller information can be stored in seller DB 222, and buyer information can be stored in buyer DB 232. In other embodiments, the functional modules could be defined differently and combined into a single module. The modules are shown as being collocated in a single system comprising one or more processors, but in other embodiments the modules could be resident in different computer systems, that could be remote to each other and configured to be accessed via network 260.

The seller module 220 can be included to manage the seller information, including the information describing the subject matter, identifying the seller, the seller's AP and LP, and contact information. The seller information can also include transaction related information, such as constraints imposed on the prospective buyers, such as minimum offer, credit rating, required pre-approvals or pre-qualifications, closing date, and the like. The seller information can be stored in the seller DB 222, e.g., in association with a seller account.

The buyer module 230 can be included to manage the buyer information, including information identifying the buyer, the buyer's OP and MP and contact information. The buyer information can also include pre-approval, pre-qualification, credit authorization, credit report access authorization, and the like. In some embodiments, the buyer information could include trade-in information. For example, if the buyer is negotiating to buy a car from the seller, the seller could entertain a trade-in of the buyer's car. Buyer information can be stored in the buyer DB 232, e.g., in association with a buyer account.

The seller module 220 can also be configured to enable the seller to input information concerning the subject matter or transaction. And the buyer module 230 can also be configured to enable the buyer to put in subject matter or transaction information. For example, the buyer could input a question requesting additional information or clarification, and the like using the buyer module and the seller could respond using the seller module. The seller could post information, such as frequently asked questions with answers, specifics about features of the subject matter, and the like.

The generation of user interface screens and information, whether web pages, e-mail, text messaging, phone calls, and the like, as examples, can be managed by a user interface module 240, which can be configured using known programs, interfaces, and links to accomplish such functions via the appropriate communications networks, links, and channels.

A third party module 250 can be configured to manage communication with third party information or service providers, such as those described herein above, as examples. In some embodiments, the automated negotiation system 200 may be accessed by seller systems, such as a car dealership or real estate broker web site. In such cases, the seller system can be treated as a third party system. In other embodiments, the automated negotiation system 200 and seller system could be combined to form a more closely integrated or standalone system.

The negotiation module 210 can be configured to determine a negotiated price (NP) or proposed negotiated price (PNP) based on the buyer and seller information, such as by the above described approaches and methods. For example, if the seller enters AP and LP and the buyer enters OP and MP, negotiation module 210 can be configured to determine NP or PNP, as appropriate. The negotiation DB 212 can store the negotiated price in association with the buyer and seller.

The negotiation module 210 can also determine whether or not a seller and buyer have met minimum requirements for conducting an automated negotiation. For example, if the seller has required that the buyer be pre-approved for financing, the negotiation module 210 can be configured to determine this, and can be configured to confirm this with the pre-approving lender or credit entity, such as in third party system 204 and via network 260.

The negotiation module 210 can also be configured to obtain advance acceptance from the buyer and seller of NP, i.e., before NP is determined. In such a case, the advance consent need not apply to the determination of PNP, where an NP could not be determined.

The negotiation module 210 can also be configured to obtain one or more of buyer and/or seller consent after determination of NP (or PNP).

The negotiation module can also be configured to enable the buyer to apply for financing before or after NP is determined, and could allow the seller's acceptance to be conditioned on such financing. The negotiation module 210 can be configured to attempt to obtain financing at NP, or at NP plus closing costs.

The negotiation module 210 could be configured to provide automated notification of one or more of the determination of NP (or PNP), acceptance of NP (or PNP) by the buyer, acceptance of NP (or PNP) by the seller, finance approval, transaction completion and the like.

The negotiation module 210 could be configured to perform title or lien searching or recording of a title or lien related to the subject matter of the transaction. In the case where the subject matter is a vehicle, for example, the negotiation module 210 can be configured to verify the title and ownership of the vehicle, using third party systems 204. If the buyer offers a trade-in, the system 200 could be configured to determine a trade-in value for the trade-in by accessing third party systems 204 with sales information, trade-in information, or market valuation functionality.

The negotiation system 200 could include a contract (K) module 280 configured to generate purchase and sale (P&S) agreements or other contracts or documents relating to the sale or transfer of the subject matter. A contract DB 282 can store templates for such agreements and can be used to store the agreements once drafted. For example, the agreements can be generated once NP has been determined. In a case where the subject matter is a house or a car, the contract module can generate a purchase and sale (P&S) agreement reflecting the buyer and seller inputs and the transaction details. The P&S could be e-signed by the parties, or downloadable or e-mailable and ready for signature.

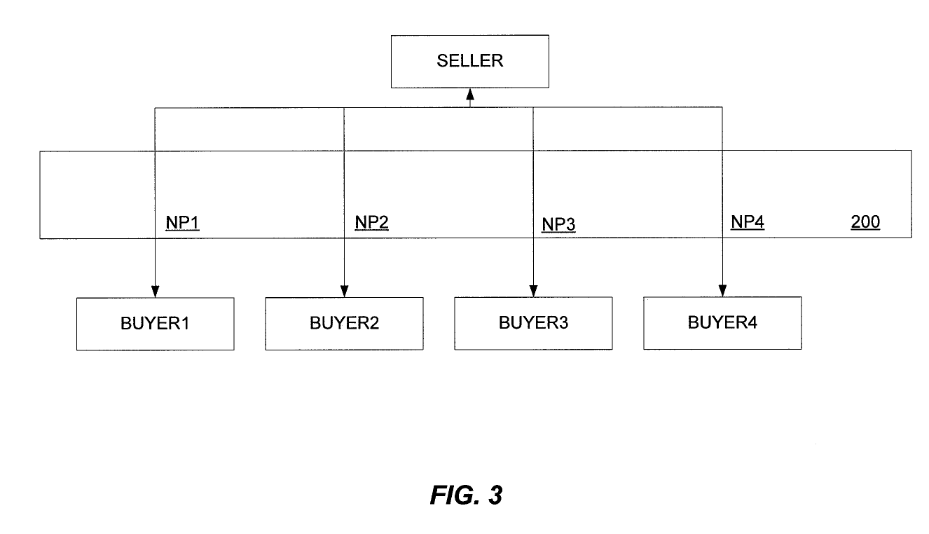

FIG. 3 is a block diagram depicting an automated negotiation system 200 implemented in a bidding context, e.g., in an auction of a property, vehicle, art, and so on. That is, in some embodiments, there could be several buyers (e.g., BN1-BN4 as in FIG. 3) bidding on the same subject matter of a given seller. In such a case, the system and method could determine an NP associated with each buyer.

In some embodiments, other factors beyond NP could additionally play into the selection. For example, a buyer with a lower NP that does not need financing and/or has no contingencies could win over a buyer with a higher NP, but that requires financing or has contingencies. Or, as another example, a buyer that can close first could be preferred over other buyers, even if that buyer has a lower NP. In such situations, a minimum NP threshold could be determined. The negotiation module 210 is configured with the logic and filters to assess and compare the bids of the buyers.

For example, the automated negotiation system 200 could determine a different NP for each buyer, e.g., NP1 for buyer 1, NP2 for buyer 2, and so on. The buyer with the highest NP can be determined as the winner. In various auction embodiments, the seller need only input a minimum bid, which could be considered the seller's lowest price LP, with no seller-entered asking price AP.

For example, the NP for each buyer could be determined using Equation (1) or (2) above.

TABLE 5

| Seller | Buyer1 | Buyer 2 | Buyer 3 |
|---|---|---|---|
| AP = — | OP = $500K | OP = $550K | OP = $500K |
| LP = $500K | MP = $750K | MP = $650K | MP = $700K |

Using Equation (2) the NP for Buyer 1 (or NP1) is ($750K+$500K)/2=$625K=NP1; NP2 for Buyer 2=($650K+$550K)/2=$600K=NP2; and NP3=($700K+$500K)/2=$600K=NP3. Therefore, NP1=$625K is the highest NP and Buyer 1 wins.

A variation of the above approach, however, can be used that yields better results for the seller. In this approach, several iterations take place to arrive at a final NP. The below Table 6 shows how these iterations take place in this embodiment based on the buyer inputs of Table 5.

TABLE 6

| | Buyer 1 | Buyer 2 | Buyer 3 | New OLl | |
|---|---|---|---|---|---|
| OLl = | $500K | $550K | $500K | $550K | 1^{st} Iteration |
| OLh = | $750K | $650K | $700K | | |
| NP = | $650K | $600K | $625K | | |
| OLl = | $650K | $650K | $650K | $650K | 2^{nd} Iteration |
| OLh = | $750K | $650K | $700K | | |
| NP = | $700K | $650K | $675K | | |
| OLl = | $700K | | $700K | $700K | 3^{rd} Iteration |
| OLh = | $750K | | $700K | | |
| NP = | $725K | | $700K | $725K | |
| NP = | $725K | | | | 4^{th} Iteration |

In Table 6, the highest OP among all buyers is set as the OLl for all buyers, while each buyer retains its MP as its OLh. Then, an NP is calculated for each buyer using Equation (2). Thus, in the 1^{st} Iteration, OLl=$550K and NP for Buyer 1 is $650K [($750K+$550K)/2), NP for Buyer 2=$600K, and NP for Buyer 3 is $625K. The highest NP becomes the new OLl for the next iteration of processing. Thus, for the 2^{nd} Iteration, the NP for Buyer 1 of $650K in the 1^{st} Iteration becomes the new OLl in the 2^{nd} Iteration. This continues for each iteration until there is only one buyer remaining. Note that in the 3^{rd} Iteration Buyer 2's MP was less than the new OLl, therefore Buyer 2 dropped out of the processing. The same thing happened in the 4^{th} Iteration for Buyer 3—leaving only Buyer 1. Thus, Buyer 1 became the winning Buyer (or bidder).

The last iteration can be handled in different ways depending on the embodiment. In the present embodiment, the new OLl for the 4^{th} Iteration, determined from the 3^{rd} Iteration, is $725K. Since Buyer 3's MP is $700K, i.e., less than the new OLl of $725K, only Buyer 1 remains. NP is chosen as the new OLl, i.e. $725K. This process is good for the seller, because if Buyer 3 would have only bid to $700K, then Buyer 1 might not have bid as high as $725K to win. For example, Buyer 1 could have won with a bid of $710K, i.e., $15K less than the NP determined by the above process.

Another approach to processing the OP and MP of the Buyers is to use only data from the two buyers having the two highest MPs, and discard the other Buyers. The Buyer with the highest MP will win, as he would in a typical open auction. Thus, using the data from Table 5, Buyer 1 above wins because its MP of $750K is the highest among all Buyers. NP can be calculated using Equation (2) where OLh=MP of Buyer 1 (i.e., highest MP) and OLl is the MP of Buyer 3 (i.e., the second highest MP). Therefore, NP=($750K+$700K)/2=$725K. This approach produces the same result as above, but with less processing.

In either of the above approaches, the final NP can be calculated differently. For example, the winner can be determined as the Buyer with the highest MP. And NP can be determined as the second highest MP, plus an additional amount. The additional amount can be made equal to a predetermined minimum bid increment, but capped at the highest MP. For example, if the second highest MP is $700K and the bid increment was $20K, then the final NP would be $720K and Buyer 1 would win. The $720K is not greater than Buyer 1's original MP, so would presumably be acceptable to Buyer 1.

If the bid increment were $100K, then NP would be $800K (i.e., $700K+$100K), but would be subject to the cap of the highest MP (i.e., of $750K). Therefore, the final NP would be $750K.

In another embodiment, NP could be determined based on a percentage, e.g., 5% more than the second highest MP. Again, this could be subject to a cap of the highest MP. So, in the above example, NP could be determined as 1.05×$700K=$735K.

In still another embodiment, NP could be determined based on a predetermined ratio of the difference between the highest MP and the second highest MP. In the above example, if the ratio were 0.6, then the final NP would be $700K+($750K-$700K)×0.6=$730K.

If more than one buyer has the same MP, then the system can prompt the buyers to enter new MPs until one buyer has the highest MP.

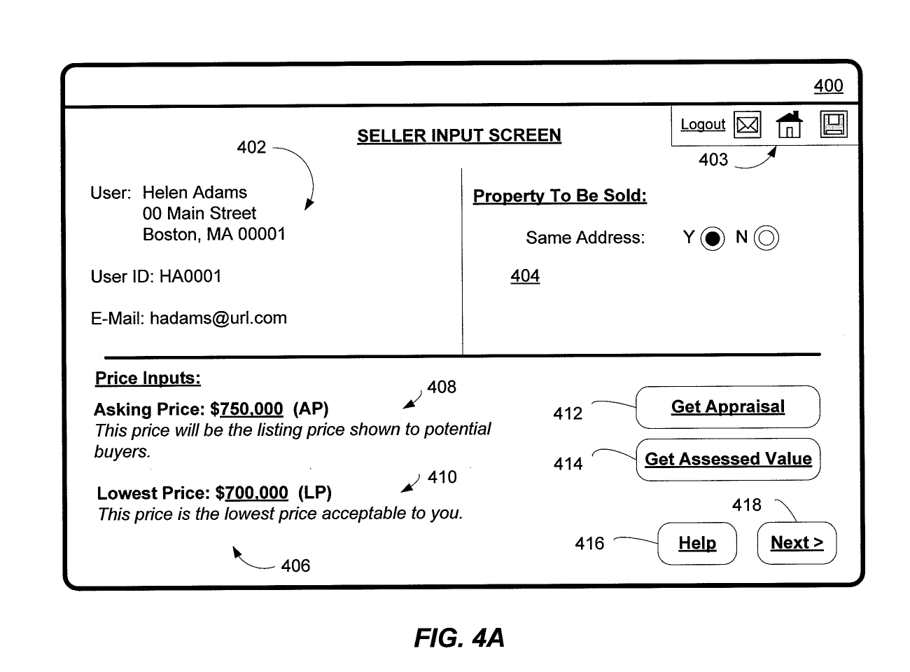

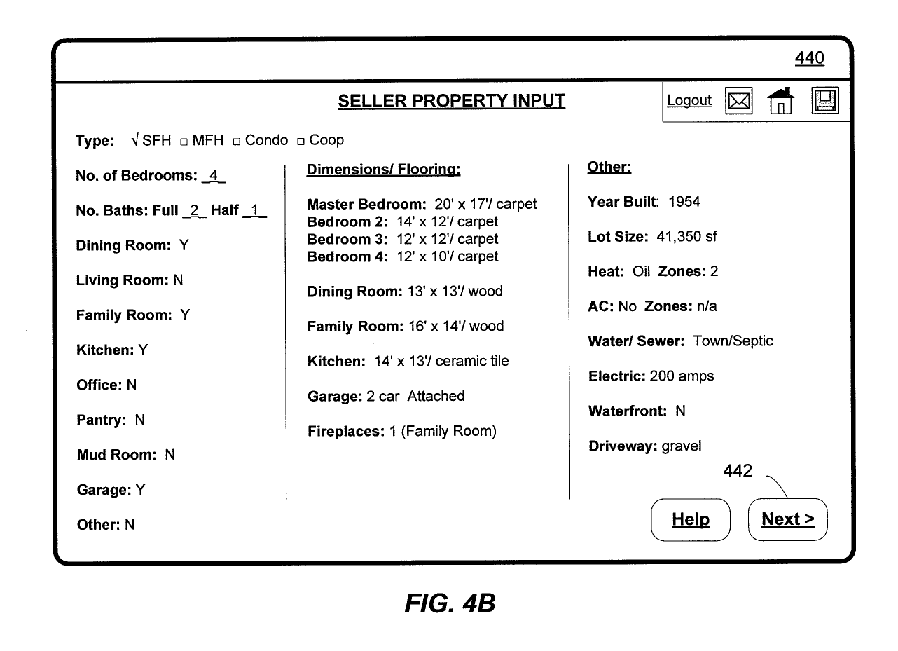

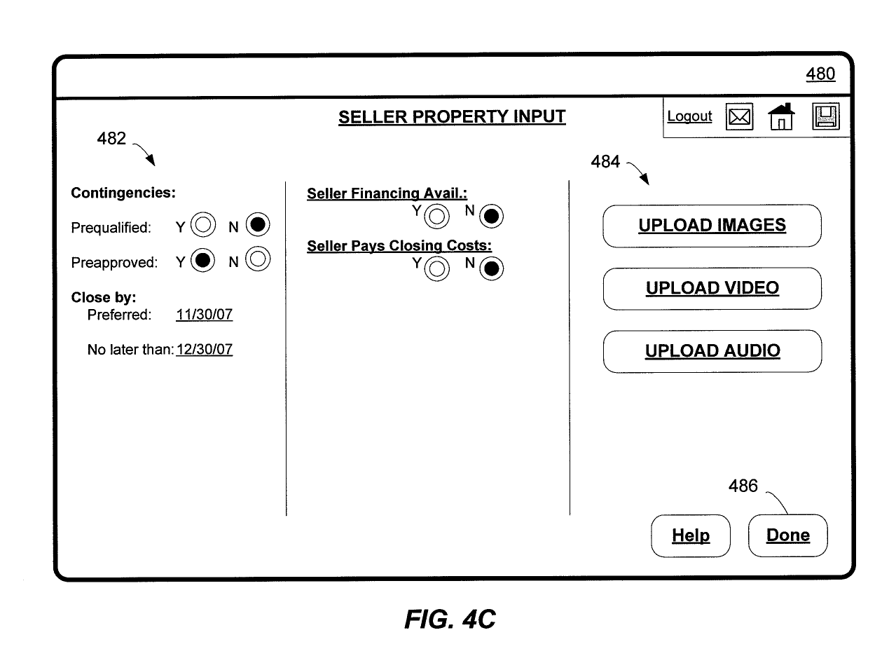

FIGS. 4A-4C is an embodiment of a set of seller input screens in a real estate context. FIG. 4A provides an embodiment of a first seller input screen 400. In the preferred form, a seller establishes an account with the system, e.g., system 200, and the seller's information is stored for use by the system. Screen 400 includes a user identification section 402 that includes user identification information. In this case, section 402 shows the user's name, address, ID, and e-mail address.

A set of active icons representing typical functions can also be included. In this embodiment, a logout icon is included to enable the user to terminate its session. A home icon is included to transition the user to a main page of the system. A save icon is included to enable the user to save data during and at the end of its session. And an e-mail icon can be included to enable the user to generate and send e-mails to the system for help or through the system to other users. For example, the user could send an e-mail responding to a question of a potential buyer. Preferably e-mail through the system is “double-blind” so users are not exposing their day-to-day identities or e-mail addresses to each other.

Screen 400 also includes a property identification section 404 where the user can identify the subject matter to be sold, here real estate. In this example, the user is presented with an option for selecting yes or no to a “Same Address” prompt. If the user is intending to sell the property having the address shown in section 402, then the user selects “Y” in section 404. Else the user selects “N” and section 404 transitions to show a set of address input fields to enable the user to enter an address of a property to be sold.

A price input section 406 prompts the user to enter an asking price (AP) 408 and a lowest price (LP) 410. In this embodiment the user entered an AP of $750,000 and an LP of $700,000. This will be used for automated negotiation. Section 406 can optionally include a button 412 labeled “Get Appraisal,” selection of which can prompt a user to input payment information (e.g., credit card info) to enable the system to obtain an electronic market appraisal from, for example, a third party provider. Section 406 can also optionally include a button 414 labeled “Get Assessed Value,” selection of which can return an assessed value from the local government used for tax purposes from, for example, the town within which the property is located.

Screen 400 can also include a button 416 labeled “Help,” selection of which can present on-line help in the form of text, video, and/or audio of stored information or access to a live operator or automated question & answer system. Screen 400 can also include a button 418 labeled “Next>,” selection of which transitions to a screen 440 of FIG. 4B.

Screen 440 enables a user/seller to enter information descriptive of the property. For example, the number and sizes of the rooms in the property, the year built, the lot size, etc. Screen 440 can include a button 422 labeled “Next>,” selection of which transitions to a screen 480 of FIG. 4C.

Screen 480 enables a user to enter transaction information. For example, a contingencies section 482 can enable a user to indicate whether or not a potential buyer must be pre-qualified or pre-approved for a mortgage before the buyer can negotiate. The seller can enter preferred and/or required closing dates that a buyer must agree to. There can also be options to indicate whether seller financing is available or whether the seller will pay closing costs. A media section 484 can include a set of buttons that enable a user to upload images, video, audio, or a combination thereof showing or describing the property. Screen 480 can include a button 486 labeled “Done,” selection of which can save the seller's information. The seller's ad can then be posted online and automated negotiation can take place.

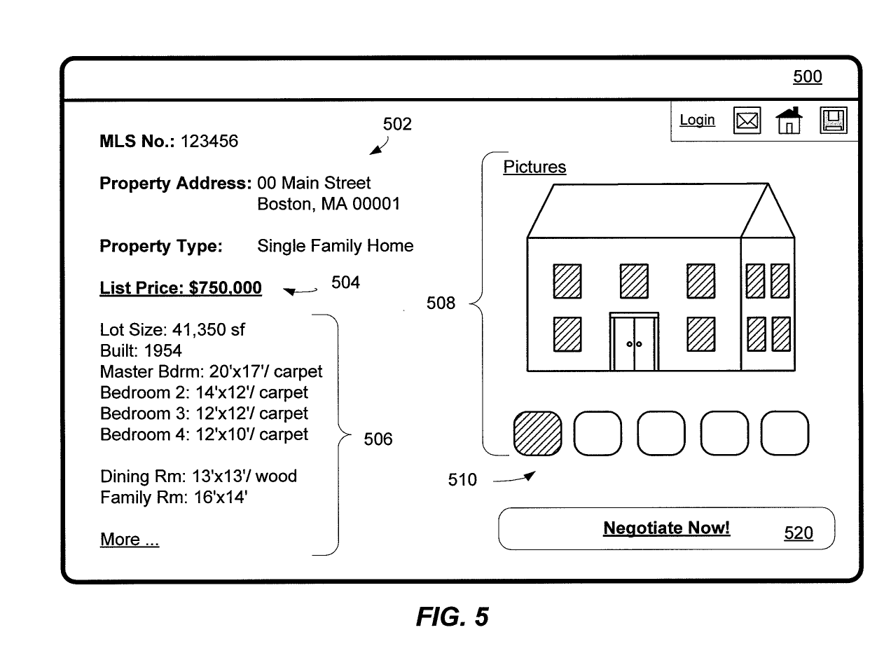

FIG. 5 is an embodiment of a screen 500 listing the property for sale based on the seller's inputs via the screens of FIGS. 4A-C, or the equivalent. The screen identifies the property by multi-listing service (MLS) number; address, and property type in section 502. The screen also identifies the “List Price” 504 of $750,000, which is the seller's asking price (AP) 408 entered through the screen of FIG. 4A. In section 506 property information is provided. In media section 508 pictures of the property are rendered, which are selectable from picture icons 510. Video and audio could also be presented in section 508, or in a separate window (not shown). A button 520 labeled “Negotiate Now!” is included.

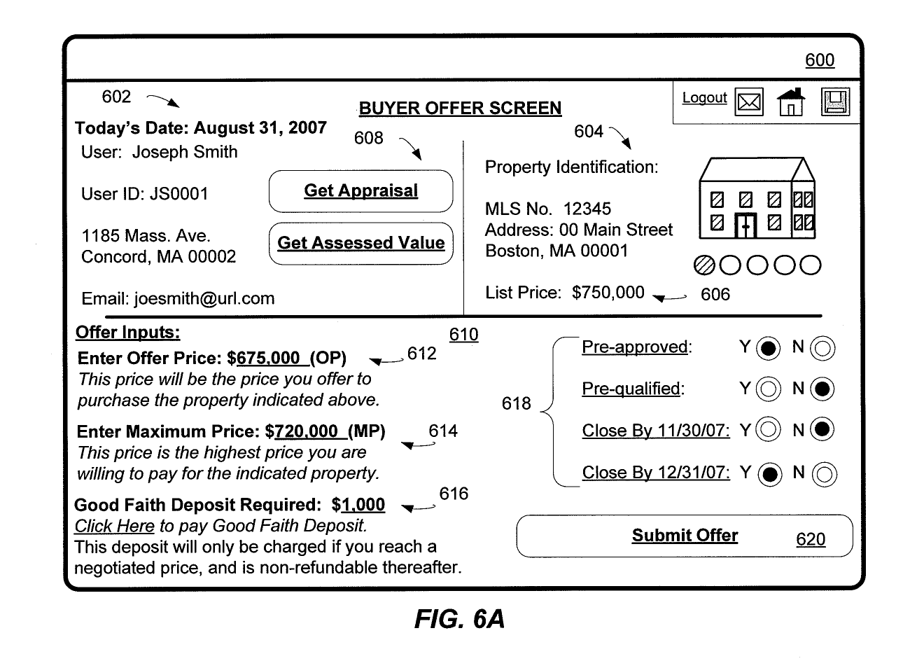

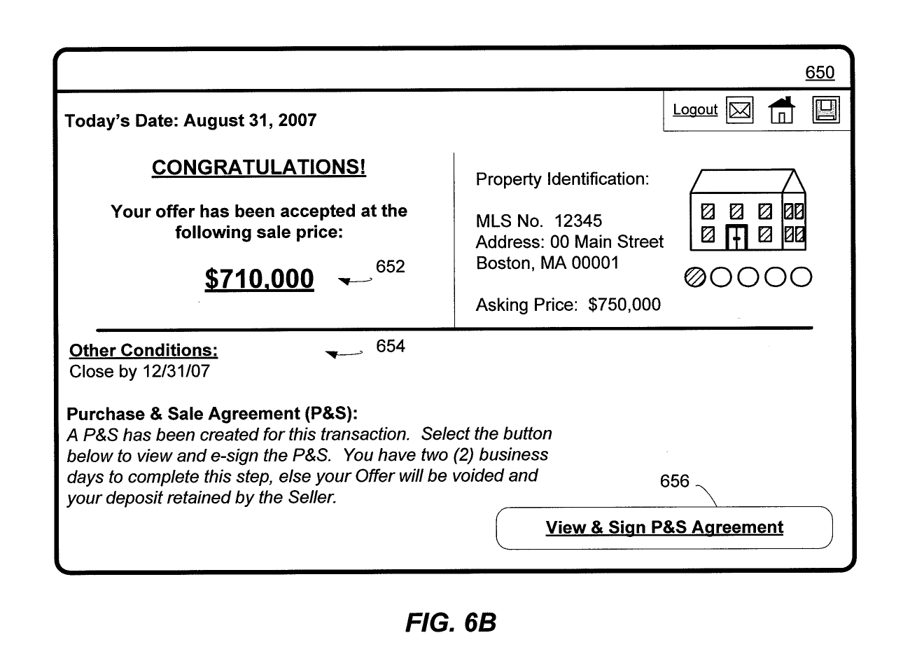

Selecting button 520 transitions the user to a Buyer Offer Screen, such as the embodiment shown as screen 600 in FIG. 6A. Screen 600 includes a buyer identification section 602 that identifies the date, buyer's/user's name and address, user ID, and user's e-mail address. Screen 600 presumes the user has an account and has logged into that account. Other embodiments need not require a user login at this stage or at all. A property identification section 604 shows information from screen 500 that identifies the subject matter of the negotiation, along with the “List Price” 606 of $750,000. A set of subject matter price information buttons 608 may be included to enable the buyer/user to obtain independent price information regarding the property. In this embodiment buttons 608 include a “Get Appraisal” button that enables the user to get a real-time appraisal from any of a variety of electronically accessible third party appraisal systems, such as CASA by Fiserv Inc. Additionally, or alternatively, a “Get Assessed Value” button can be provided that enables the buyer/user to obtain the assessed value of the property for tax purposes, e.g., as available from the local taxing authority.

Another section 610 of screen 600 is used for buyer/user inputs, such as Offer Price (OP) 612 (here, $675,000) and Maximum Price 614 (here, $720,000). These inputs are used for automated negotiation. A Good Faith Deposit 616 (here, $1,000) may be required for a buyer to submit an offer. The deposit could be paid by credit card or by other type of electronic funds transfer (EFT). Section 610 may also include a section 618 for secondary transaction inputs that reflect the seller's inputs screen 480 of FIG. 4C. In this case, screen 600 solicits input identifying whether the buyer is “Pre-approved” or “Pre-qualified.” Screen 600 also solicits inputs regarding closing date possibilities. Other secondary transaction inputs could also be solicited, e.g., whether a contingency is required for the buyer to sell its current property. The secondary transaction inputs can be used as filters or weighting parameters in determining a best offer among a plurality of offers. Once all inputs have been made, the buyer can select button 620 labeled “Submit Offer.”

Selection of button 620 causes the automated negotiation system, e.g., system 200, to perform an automated negotiation. Any of the above described negotiation approaches, or substantially equivalent approaches, can be used. In a highly automated form of negotiation, neither the buyer nor seller is required to take an additional step to approve or accept the negotiated price (NP) before it is made final. But in other embodiments, one or both of the buyer and seller could be required to accept NP before it is made final, even if NP falls within the seller's price range and the buyer's price range.

FIG. 6B shows an embodiment of a screen 650 that shows the buyer the results of a successful automated negotiation. Screen 650 shows that an NP of $710,000 has been determined. This has been calculated according to Equation (2) above, given the seller's AP=$750K and LP=$700K and the buyer's OP=$675K and MP=$720K. That is, NP=($720K+$700K)/2=$710,000. “Other Conditions” can be shown in section 654, such as the requirement to “Close by Dec. 31, 2007,” which was determined based on the seller's and buyer's inputs.

In the preferred form, the system generates a purchase and sale agreement (P&S) based on the seller's and buyer's inputs, which can be viewed and e-signed via selection of button 656. In some embodiments the P&S need not be e-signed, but could be printed and signed. In other embodiments the P&S can be e-mailed to the buyer and seller and their respective attorneys prior to being e-signed or printed and signed. This would require the seller and buyer to have entered e-mail addresses for their respective attorneys.

In other embodiments, the buyer's bank or mortgage company could be electronically notified, so that they can commence appraisal, title, and other necessary activities in time for the agreed to closing date. This could require the buyer to have entered an e-mail address for its bank or mortgage company.

In other embodiments, the system could automatically, or in response to a buyer request, seek financing for the buyer at NP (or above NP), for example through electronic application systems and processing.

When an NP is determined, so a buyer is also determined, the system can automatically notify the seller, e.g., e-mail, text, message, phone call, or the like. If a seller acceptance or other input is required, such notification can solicit such acceptance or input.

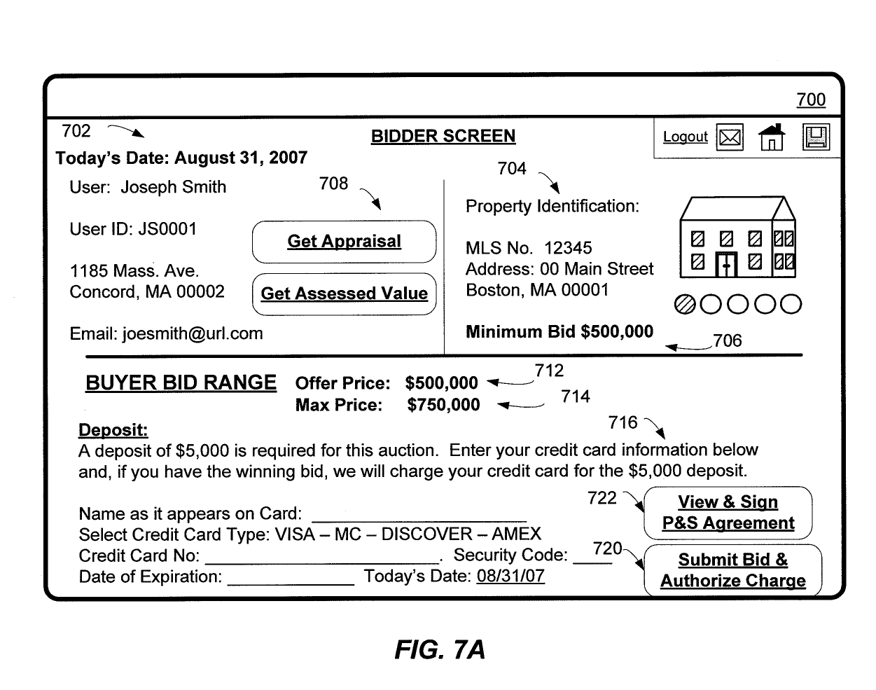

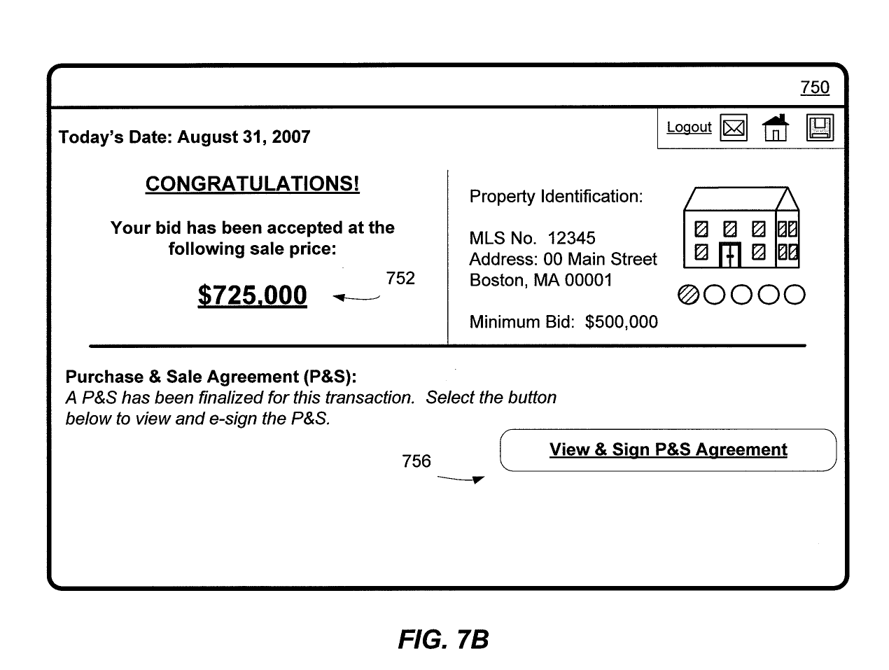

FIG. 7A is an embodiment of an auction bidder input screen and FIG. 7B is an embodiment of a successful bidder notification screen. Screen 700 includes a buyer (or bidder) identification section 702 that identifies the date, buyer's/user's name and address, user ID, and user's e-mail address. Screen 700 presumes the user has an account and has logged into that account. Other embodiments need not require a user login at this stage or at all. A property identification section 704 shows information from a seller's screen that identifies the subject matter of the auction, along with the “Minimum Bid” 706 of $500,000. A set of subject matter price information buttons 708 may be included to enable the buyer/user to obtain independent price information regarding the property. In this embodiment buttons 708 include a “Get Appraisal” button that enables the user to get a real-time appraisal from any of a variety of electronically accessible third party appraisal systems, such as CASA by Fiserv Inc. Additionally, or alternatively, a “Get Assessed Value” button can be provided that enables the buyer/user to obtain the assessed value of the property for tax purposes, e.g., as available from the local taxing authority.

Another section 710 of screen 700 is used for buyer/user inputs, such as Offer Price (OP) 712 (here, $500,000) and Maximum Price 714 (here, $750,000). These inputs are used for automated negotiation. A Good Faith Deposit 716 (here, $5,000) may be required for a buyer to submit an offer. The deposit could be paid by credit card or by other type of electronic funds transfer (EFT). Section 710 may also include a section (not shown) for secondary transaction inputs that reflect the seller's inputs, as with screen 480 of FIG. 4C. Secondary transaction inputs could include whether the buyer was pre-qualified or pre-approved, or whether a contingency is required for the buyer to sell its current property. The secondary transaction inputs can be used as filters or weighting parameters in determining a best offer among a plurality of offers. Once all inputs have been made, the buyer can select button 720 labeled “Submit Bid & Authorize Charge.”

Screen 700 includes a button 722 labeled “View & Sign P&S Agreement,” demonstrating that a P&S can be signed in advance contingent upon the buyer being the successful bidder. This approach could have been used with the screens of FIGS. 6A and 6B. Conversely, the approach of FIGS. 6A and 6B, where the P&S is viewed and signed after successful negotiation could be used in the auction embodiment.

Selection of button 720 causes the automated negotiation system, e.g., system 200, to perform an automated negotiation. Any of the above described negotiation approaches, or substantially equivalent approaches, can be used. In a highly automated form of negotiation, neither the buyer nor seller is required to take an additional step to approve or accept the negotiated price (NP) before it is made final. But in other embodiments, one or both of the buyer and seller could be required to accept NP before it is made final, even if NP falls within the seller's price range and the buyer's price range.

FIG. 7B shows an embodiment of a screen 750 that shows the buyer the results of a successful automated negotiation in an auction context. Screen 750 shows that an NP of $725,000 has been determined. This can be calculated as discussed above with respect to Tables 5 and 6 above. Other conditions could be shown in, such as the requirement to close by a date certain.

In the preferred form, the system generates a purchase and sale agreement (P&S) based on the seller's and buyer's inputs, which can be viewed and e-signed via selection of button 756, e.g., if it was not done using button 722 in FIG. 7A. In some embodiments the P&S need not be e-signed, but could be printed and signed. In other embodiments the P&S can be e-mailed to the buyer and seller and their respective attorneys prior to being e-signed or printed and signed. This would require the seller and buyer to have entered e-mail addresses for their respective attorneys.

In other embodiments, the buyer's bank or mortgage company could be electronically notified, so that they can commence appraisal, title, and other necessary activities in time for the agreed to closing date. This could require the buyer to have entered an e-mail address for its bank or mortgage company.

In other embodiments, the system could automatically, or in response to a buyer request, seek financing for the buyer at NP (or above NP), for example through electronic application systems and processing.

When an NP is determined, so a buyer is also determined, the system can automatically notify the seller, e.g., e-mail, text, message, phone call, or the like. If a seller acceptance or other input is required, such notification can solicit such acceptance or input.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A method of automated negotiation, implemented using one or more computers, the method comprising:
storing in at least one negotiation database a set of seller information comprising:
a subject matter identification and a set of seller price information including an asking price and a lowest price, the subject matter identification identifying a subject matter of a negotiation, and
a set of buyer information comprising a set of buyer price information including an offer price and a maximum price for the subject matter; and
determining a negotiated price from the seller price information and the buyer price information.

2. The method of claim 1, further comprising determining a seller price range defined by the asking price and the lowest price, and determining a buyer price range defined by the offer price and the maximum price.

3. The method of claim 2, further comprising determining an overlap of the seller price range and the buyer price range and determining the negotiation price to be within the overlap.

4. The method of claim 3, further comprising determining the overlap as a range having one end point at the higher of the lowest price and offer price and another end point at the lower of the asking price and maximum price.

5. The method of claim 3, further comprising determining the negotiated price as a midpoint of the overlap.

6. The method of claim 1, further comprising determining the negotiated price by weighting at least one of the seller price information and buyer price information.

7. The method of claim 1, further comprising determining the negotiated price as a proposed negotiated price if the seller lowest price is greater than the buyer maximum price.

8. The method of claim 7, further comprising determining the proposed negotiated price as being between the seller lowest price and the buyer maximum price.

9. The method of claim 1, further comprising determining a market value of the subject matter and determining the negotiated price as a further function of the market value.

10. The method of claim 9, further comprising determining the negotiated price as being within a predetermined percentage of the market value.

11. The method of claim 1, further comprising determining the negotiated price only if the set of seller information includes information indicating a commitment to sell the subject matter at the negotiated price, prior to determination of the negotiated price.

12. The method of claim 1, further comprising determining the negotiated price only if the set of buyer information includes information indicating a commitment to buy the subject matter at the negotiated price, prior to determination of the negotiated price.

13. The method of claim 1, further comprising providing a user interface for enabling the input of at least one of the seller information and buyer information to the at least one negotiation database.

14. The method of claim 1, further comprising generating and transmitting a notification configured for presentation via a user device in response to a determination of the negotiated price, the notification including the negotiated price.

15. The method of claim 14, further comprising providing the notification as at least one of a page for display in a browser, an e-mail, a text, message, or an automated phone call.

16. The method of claim 1, further comprising generating a contract for the purchase of the subject matter by the buyer and from the seller for the negotiated price.

17. The method of claim 1, wherein the subject matter can be real estate.

18. The method of claim 1, wherein the subject matter can be at least one vehicle.

19. A negotiation system comprises:
at least one negotiation database configured to store:
a set of seller information comprising a subject matter identification and a set of seller price information including an asking price and a lowest price, the subject matter identification identifying a subject matter of a negotiation;
and a set of buyer information comprising a set of buyer price information including an offer price and a maximum price for the subject matter; and
a negotiation module configured to determine a negotiated price from the seller price information and the buyer price information.

20. The system of claim 19, wherein the negotiation module is further configured to determine an overlap of the seller price range and the buyer price range and to determine the negotiation price to be within the overlap.

21. An auction negotiation system comprises:
at least one negotiation database configured to store:
a set of seller information comprising a subject matter identification and a set of seller price information including an asking price and a lowest price, the subject matter identification identifying a subject matter of a negotiation; and,
for each of a plurality of buyers, a set of buyer information comprising a set of buyer price information including an offer price and a maximum price for the subject matter; and
a negotiation module configured to determine a negotiated price associated with each buyer from the seller price information and the respective buyer price information.

22. The system of claim 21, wherein the negotiation module is configured to determine a winning bid as a function of the negotiated prices.

23. A method of automated auction negotiation, implemented using one or more computers, the method comprising:
storing in at least one negotiation database a set of seller information comprising:
a subject matter identification and a set of seller price information including an asking price and a lowest price, the subject matter identification identifying a subject matter of a negotiation; and,
for each of a plurality of buyers, a set of buyer information comprising a set of buyer price information including an offer price and a maximum price for the subject matter; and
determining a negotiated price associated with each buyer from the seller price information and the respective buyer price information.

24. The method of claim 23, further comprising determining a winning bid as a function of the negotiated prices.
